(19) United States
(12) Patent Application Publication
(10) Pub. No.: US 2007/0016906 A1
(43) Pub. Date: Jan. 18, 2007

(54) Efficient hardware allocation of processes to processors

(75) Inventors: Richard D. Trauben, Morgan Hill, CA (US); Jonathan Sweedler, Los Gatos, CA (US); Rajesh Nair, Fremont, CA (US)

Correspondence Address: MARGER JOHNSON & MCCOLLOM, P.C., 210 SW MORRISON STREET, SUITE 400, PORTLAND, OR, 97204, US

(73) Assignee: Mistletoe Technologies, Inc., Cupertino, CA (US)

(21) Appl. No.: 11/184,424

(22) Filed: Jul. 18, 2005

(51) Int. Cl. G06F 9/46

(52) U.S. Cl. 718/102

(57) ABSTRACT

A dispatcher module has a queue to store task requests. The dispatcher also has a task arbiter to select a current task for assignment from the task requests and a unit arbiter to identify and assign the task to an available processing unit, such that the current task is not assigned to a previously-assigned processing unit.

### REFERENCE TO RELATED APPLICATIONS

Copending U.S. patent application Ser. No. 10/351,030, titled “Reconfigurable Semantic Processor,” filed by Somsubhra Sikdar on Jan. 24, 2003, is incorporated herein by reference.

### BACKGROUND

Computer architectures typically use von Neumann architectures. This generally includes a central processing unit (CPU) and attached memory, usually with some form of input/output to allow useful operations. The CPU generally executes a set of machine instructions that check for various data conditions sequentially, as determined by the programming of the CPU. The input stream is processed sequentially, according to the CPU program.

In contrast, it is possible to implement a ‘semantic’ processing architecture, where the processors or processor respond directly to the semantics of an input stream. The execution of instructions is selected by the input stream. This allows for fast and efficient processing. This is especially true when processing packets of data.

Many devices communicate, either over networks or back planes, by broadcast or point-to-point, using bundles of data called packets. Packets have headers that provide information about the nature of the data inside the packet, as well as the data itself, usually in a segment of the packet referred to as the payload. Semantic processing, where the semantics of the header drive the processing of the payload as necessary, fits especially well in packet processing.

In some packet processors, there may be several processing engines. Efficient dispatching of the tasks to these engines can further increase the speed and efficiency advantages of semantic processors.

### SUMMARY

One embodiment is a dispatcher module operates inside a semantic processing having multiple semantic processing units. The dispatcher includes one or more queues to store task requests. The dispatcher also includes a task arbiter to select a current task for assignment from the task requests, and a unit arbiter to identify and assign the task to an available processing unit, such that the current task is not assigned to a previously-assigned processing unit.

Another embodiment is a semantic processor system having a dispatcher, a parser, an ingress buffer and an egress buffer.

Another embodiment is a method to assign task among several processing units.

### BRIEF DESCRIPTION OF THE DRAWINGS

Embodiments of the invention may be best understood by reading the disclosure with reference to the drawings, wherein:

FIG. 1 shows an embodiment of a portion of a semantic processing system.

FIG. 2 shows an embodiment of a hardware dispatcher.

FIG. 3 shows an embodiment of task request queue circuitry.

FIGS. 4a-4b show embodiments of status circuitry.

FIG. 5 shows a flowchart of an embodiment of an arbitration process.

### DETAILED DESCRIPTION OF THE EMBODIMENT

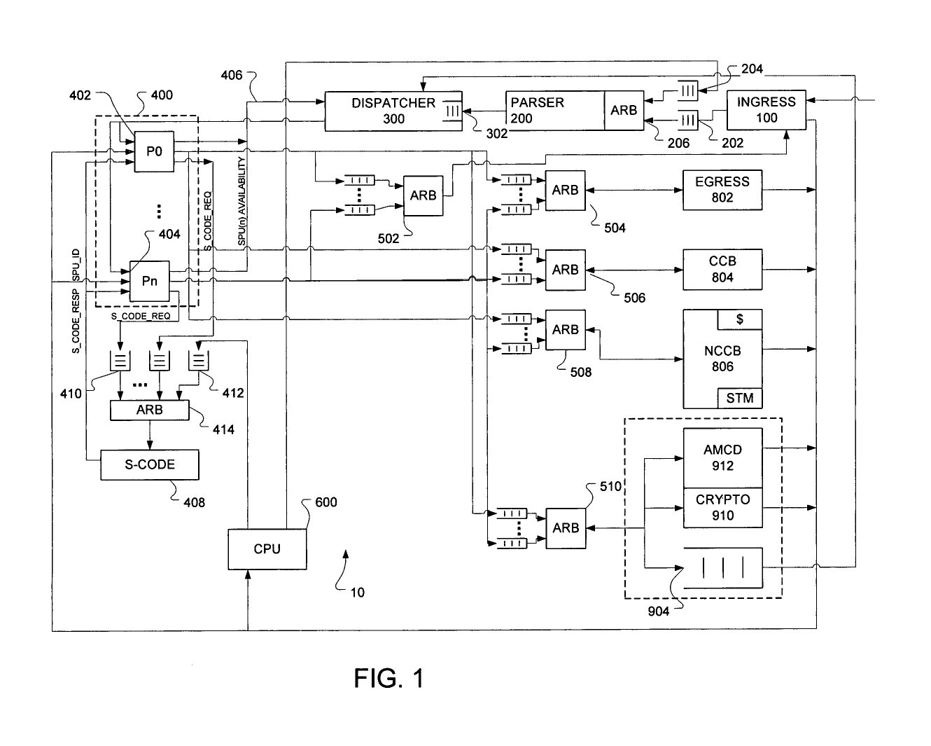

FIG. 1 shows a block diagram of a semantic processor 10. The semantic processor contains an ingress, or input, buffer 100 for buffering a data stream, also referred to as the input stream, received through an input port, not shown. The processor also contains a direct execution parser (DXP) 200 that controls the processing of packets in the input buffer 100. In addition to the parser, the processor includes an array of semantic processing units 400, also referred to as processing units, to process segments of the incoming packets or other operations and a dispatcher 300. The processor interfaces with a memory subsystem comprised of ingress buffer memory 100, ‘scratch pad’ memory (NCCB) 806, context control block memory (CCB) 804, a classification processor (AMCD) 912, a cryptographic processor (CRYPTO) 910, a processor 402 to CPU 600 message queue 904, and an egress buffer memory 802. Arbiters 502, 508, 504, 510 and 504 control access to the ingress buffer 100, the NCCB 806, CCB 804, classification & cryptographic engines and message queue 912,910, 904 and the egress buffer 804. The S_CODE table has queues such as 410 for the SPUs and queue 412 for the CPU arbitrated by arbiter 414. The parser has queue 202 for the ingress buffer and queue 204 for the CPU 600 also contained in the processor, arbitrated by arbiter 206.

When a packet is received at the buffer 100, it notifies the parser 200 that a packet has been received by placing the packet in the queue 202. The parser also has a queue 204 that is linked to the CPU 600. The CPU initializes the parser through the queue 204. The parser then parses the packet header and determines what tasks need to be accomplished for the packet. The parser then associates a program counter, referred to here as a semantic processing unit (SPU) entry point (SEP), identifying the location of the instructions to be executed by whatever SPU is assigned the task and transfers it to the dispatcher 300. The dispatcher determines what SPU is going to be assigned the task, as will be discussed in more detail later.

The dispatcher 300 broadcasts information to the SPU cluster comprised of SPUs such as processing unit P0 402 through processing unit Pn 404, where n is any number of desired processors, via three busses: disp_allspu_res_vld; disp_allspu_res_spuid; and disp_allspu_res_isa, such as 406. Each SPU in the cluster sends SPU(n)_IDLE status to the dispatcher to avoid a new task assignment while working on a previously assigned, uncompleted task.

The SPUs may employ a semantic code table (S-CODE) 408 to acquire the necessary instructions that they are to execute. The SPUs may already contain the instructions needed, or they may request them from the S-CODE table 408. A request is transmitted from the processing unit to the queues such as 410, where each SPU has a corresponding queue. The CPU has its own queue 412 through which it initializes the S-CODE RAM with SPU instructions. The S-CODE RAM broadcasts the requested instruction stream along with the SPU ID of the requesting SPU. Each processor decodes the ‘addressee’ of the broadcast message such that the requesting processing unit receives its requested code.

The assignment of the tasks to the SPUs determined by the parser 200 is handled by the dispatcher 300 by examining the contents of several pending task queues 302, 902,904, 906. Queue 902 stores requests from the parser to the SPUs. Queue 904 stores requests between SPUs. One SPU assigned a particular task may need to spawn further tasks to be executed by other SPUs or the CPU, and those requests may be stored in queue 906. SPU to SPU and SPU to CPU message queue messages are written by arbiter 510, which may also provide access to the cryptographic key and next hop routing database 910 within the array machine context data (AMCD) memory 912.

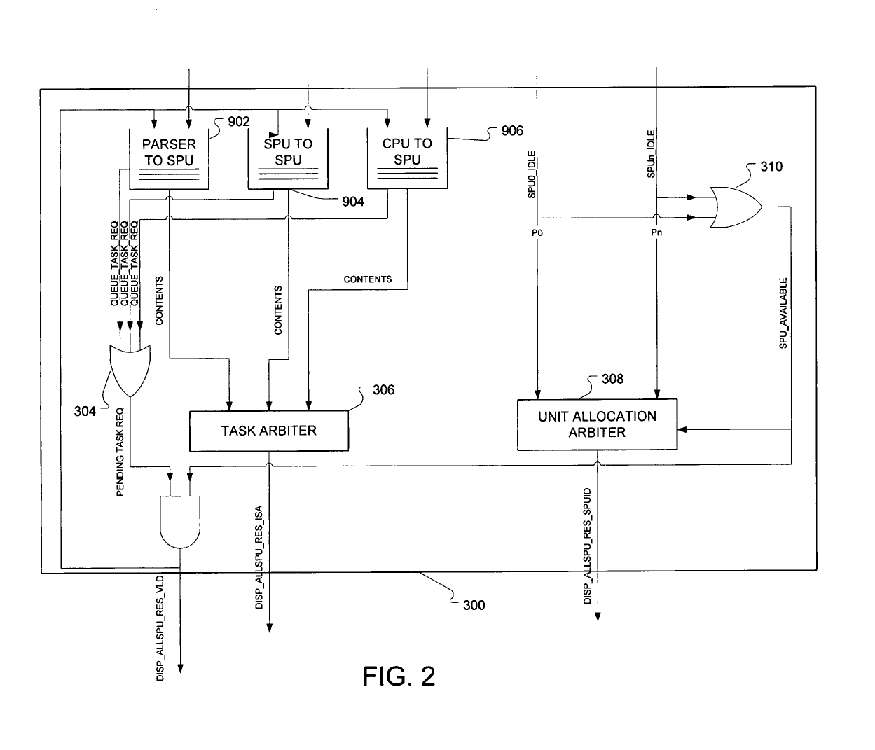

The dispatcher 300 monitors these queues and the status of the SPU array 400 to determine if tasks need to be assigned and to which processor. An embodiment of a dispatcher is shown in FIG. 2. The dispatcher 300 monitors the queues that control assignment to the SPUs, either from the other SPU such as in queue 904, from the parser to the SPUs, and from the CPU to the SPUs. These last three queues may be ‘sub’ queues of queue 302 of FIG. 1. They will be referred to here as queues 902 and 906. The queues may be memories, within a region of the memory resident in the dispatcher or located elsewhere.

Each subqueue has a connection to the task arbiter 306. While there are two connections shown, and the logic gate 304 is shown external to the task arbiter, there may be one connection and the logic gate 304 may be included in the task arbiter. For ease of discussion, however, the gate is shown separately. The task arbiter receives the task contents from the queues and determines their assignment. The logic gate 304 receives the task requests and provides an output signal indicating that there is a pending task request. The pending task request is gated with the SPU_AVAILABLE signal from the gate 310 to produce the signal DISP_ALLSPU_RES_VLD.

The unit allocation arbiter 308 receives that signal and determines which SPU should be assigned the task, based upon the availability signals SPU(n)_IDLE from the various SPUs and outputs this as DISP_ALLSPU_RES_SPUID. This will be discussed with more detail further.

In addition to the valid response signal, the dispatcher sends out a signal identifying the ‘place’ in the instructions the SPU is to execute the necessary operations. This is referred to as the SPU Entry Point (SEP). When the task is from the parser to the SPU, for example, the dispatcher provides the initial SEP address (ISA) as a program counter as well as an offset into the ingress buffer to allow the SPU to access the data upon which the operation is to be performed. The offset may be provided as a byte address offset into the ingress buffer. When the task is from the CPU to the SPU, for example, the program counter and the arguments may be provided to the SPU. When the task is from one SPU to another SPU, the dispatcher may pass the arguments and the program counter as well. This information is provided as the signal DISP_ALLSPU_RES_ISA.

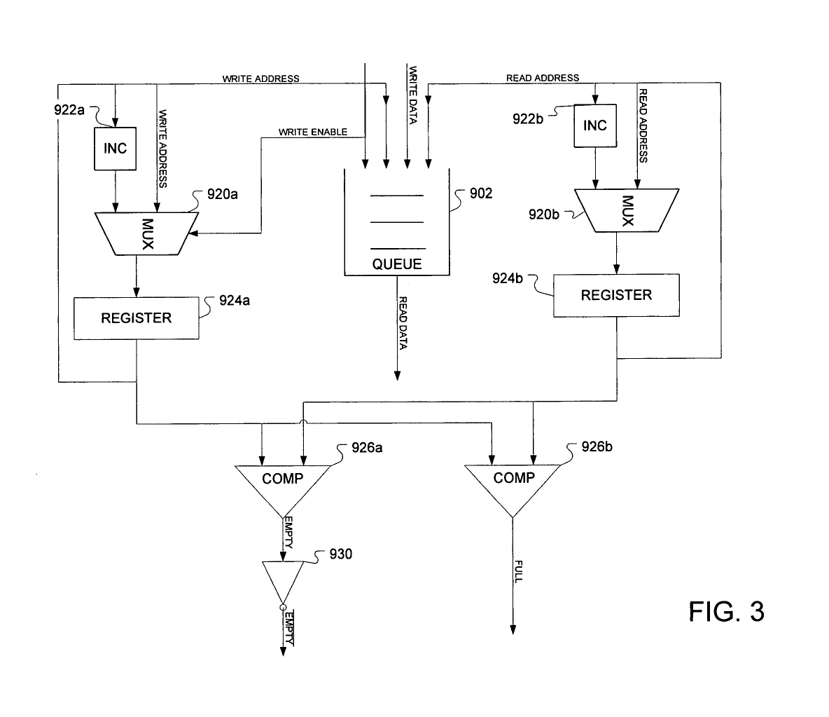

One embodiment of circuitry to queue and detect unassigned pending tasks is shown in FIG. 3. The queue, being a memory of some type, may have a read pointer (R/P) and a write pointer (W/P). The write pointer gets advanced as new tasks come in to the queue. They remain there until they are accessed by the task arbiter for assignment and processing. The read pointer does not advance until the task is assigned. By comparing the read pointer to the write pointer, it is possible to determine if there is a pending task from the specified task source queue.

In FIG. 3, the queue 902 receives four inputs: a write enable signal; a write address signal; a write data signal; and a read address signal. As tasks are assigned from a queue, the write address signal is incremented. The multiplexer 920a receives two inputs, the write address and the next incremented write address from incrementer 922a. The multiplexer is enabled by the write enable signal. When the write enable signal is enabled, the next write address is used, incrementing the write address seen by the queue and stored in register 924a. The read address pointer is incremented in a similar manner as the write pointer, using multiplexer 920b, with incrementer 922b and register 924b.

The write pointer and the read pointer may be one bit wider than necessary. For example, if the addresses are 3 bits, the pointers will be 4 bits wide. If the pointers are identical, there are no pending tasks. If the two are different, there is a pending task. The extra bit is used to detect a wrap around condition if the queue is full, allowing the system to stall on writing requests until the number of pending entries has decreased . . . For example, if the 3 bits of the address are the same as ‘000’ but the fourth bit is different, the queue is full and has wrapped around back to 000. It does not matter whether the read pointer and write pointer are different in any manner, it indicates that the task queue has a pending task.

The comparison is done by a pair of comparators 926a and 926b, with the output of the comparator 926b indicating whether or not the queue is full and the output of the comparator 926a indicating whether or not the queue is empty. The queue empty signal is inverted by inverter 930 and combined with a write enable signal to assert the write enable signal used by the queue. If the queue is not empty, the write enable signal is asserted.

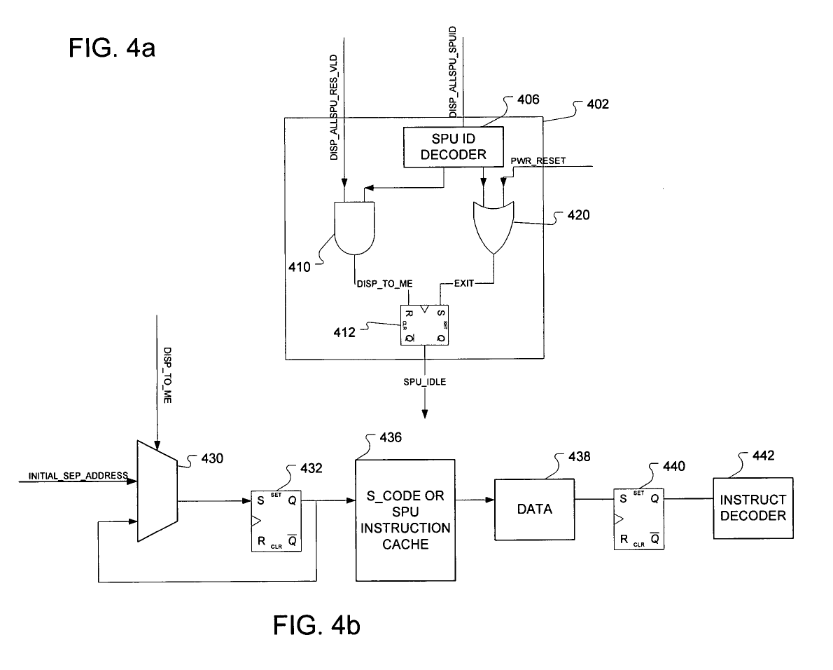

In addition to monitoring tasks requests from the queues so the task arbiter knows that at least one request is waiting, the dispatcher 300 of FIG. 2 also monitors the status of the SPUs at unit arbiter 308. Unit arbiter receives a signal from each of the SPUs indicating their status as idle or busy. A positive output of the gate 310 may provide an activation signal to the unit arbiter. An embodiment of circuitry to implement this function is shown in FIGS. 4a and 4b.

The output of the dispatcher for a task is provided to the decoder 406 of SPU 402.

The use of SPU 402 for this example is merely for discussion purposes. Any processing unit may have a state machine using this type of logic circuitry that allows it to determine if there is a task being assigned to it. The dispatcher provides a signal that indicates that there is a task to be assigned, DISP_ALLSPU_RES_VLD, and the address or other identifier of the SPU, DISP_ALLSPU_RES_SPUID. The identifier is sent to a decoder 406 and the decoder determines if the identifier matches that of the processing element 402. The output of the decoder is provided to a logic gate 420.

If either the PWR_RESET is detected or the SPU pipeline detects that is has executed an ‘EXIT’ instruction, gate 420 will set SPU(n)_IDLE at flip-flop 412 to inform the dispatch hardware that this SPU is now a candidate to execute pending task requests. If the address if for the current SPU, and the dispatcher response if valid, as determined by AND gate 410, the flip/flop outputs that the SPU is not idle. It must be noted that this is just one possible combination of gates and storage to indicate the state of the SPU. Any combination of logic and storage may be used to provide the state of the SPU to the dispatcher and will be within the scope of the claims.

As tasks are processed from the subqueues of FIG. 2, the read pointers are advanced and the task request signal to the task arbiter changes if there are no tasks pending. This in turn alters the input to the SPU, DISP_ALLSPU_RES_VLD. This then sets the SPU to idle when there are no tasks. The SPU(n)_IDLE signal is then asserted and the unit arbiter knows that there are processing resources available.

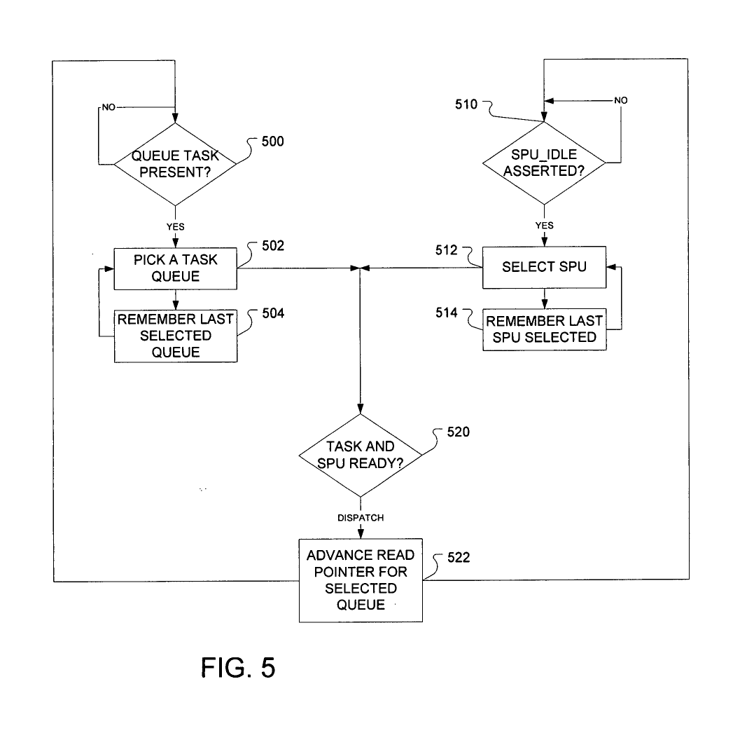

FIG. 4b shows an embodiment of circuitry that causes the SPU to load an instruction. The signal DISP_TO_ME or a signal depending upon the DISP_TO_ME signal is used as a multiplexer enable signal for multiplexer 430 to select the new initial SEP address (ISA) result from FIG. 3. The multiplexer results is stored in a register and used as a program counter to fetch the initial SEP instruction. This first instruction may reside in the SPU instruction cache or, when that cache does not already contain the required instruction, is retrieved from SCODE memory. Once the instruction is fetched as data output 438, it is then stored at queue 440. During a subsequent cycle, it is decoded by resource 442 and executed by the SPU processor pipeline. An embodiment of the process of managing tasks and units is shown in FIG. 5.

At 500, the dispatcher monitors the task queues to determine if there is a task request asserted from one of the queues. If there is a task pending, a queue containing a task is selected at 502, this is then remembered at 504. The selected task queue is ‘remembered’ to assist in the selection of the next task queue and fed back to 502.

During this process of task selection, the identification of an available SPU is performed at 510. If the SPU_IDLE signal is asserted for at least one SPU, that SPU is available to be assigned as task. If there is no SPU with SPU_IDLE asserted, then the process waits until a SPU is ready.

If one or more tasks is pending and one or more SPU are available, the dispatcher will select the next task at 512 and assign it to the next selected SPU, advance the read pointer for the selected task at 522 and remove the selected SPU from subsequent task assignment at 514 until the currently assigned task is completed. The advanced pointer is then used as described above to determine if there is a pending task request.

Returning to 502 and 512, if there is more than one SPU available, the highest priority SPU is assigned. In a round-robin task/SPU arbiter, the currently available SPU that was most recently allocated a task that has completed will be the lowest priority SPU to be allocated a task. For example, assume there were three SPUs, P0, P1 and P2. If P0 is assigned a task, then P1 and P2 would have higher priority for the next task.

Upon assignment, the processor assigned becomes the ‘previously assigned’ processor. When P1 is assigned a task, the priority becomes P2, P0 and then P1. Some tasks will take longer than others to complete, so the assignments may not be in order after some period of time. Based upon the assignment at 512, the last SPU assigned to a task, once finished with the task, is the lowest priority SPU to receive a new task assignment. The process then returns to monitoring the task queues and SPU availability.

In this manner, the dispatcher can monitor both the incoming task requests and the status of the processing resources to allow efficient dispatch of tasks for processing. Implementation of this in hardware structures and signals substantially reduces the number of cycles it takes the dispatcher to determine which processors are available and whether or not tasks are waiting. In one comparison, monitoring tasks and status using software make take 100 instructions cycles, while the above implementation only took 1 instruction cycle. This increase in efficiency further capitalizes on the advantages of the semantic processing architecture and methodology.

The embodiments provide a novel hardware dispatch mechanism to rapidly and efficiently assign pending tasks to a pool of available packet processors. The hardware evenly distributes pending task requests across the pool of available processors to reduce packet processing latency, maximize bandwidth, concurrency and equalize distribution of power and heat. The dispatch mechanism can scale to serve large numbers of pending task requests and large numbers of processing units. The mechanism for one process dispatch per cycle is described. The approach can easily be extended to higher rates of process dispatch.

Thus, although there has been described to this point a particular embodiment of a method and apparatus to perform hardware dispatch in a semantic processor, it is not intended that such specific references be considered as limitations upon the scope of this invention except in-so-far as set forth in the following claims.

What is claimed is:

1. A dispatcher module, comprising:
a queue to store task requests;
a task arbiter to select a current task for assignment from the task requests;
a unit arbiter to identify and assign the task to an available processing unit, such that the current task is not assigned to a previously-assigned processing unit.

2. The dispatcher module of claim 1, the queue to store task requests further comprising a memory.

3. The dispatcher module of claim 1, a queue further comprising a subqueue for processing unit to processing unit tasks, a subqueue for central processing unit to processing unit tasks, and a subqueue for parser to processing unit tasks.

4. The dispatcher module of claim 1, the queue having a read pointer and a write pointer.

5. The dispatcher module of claim 1, the queue further comprising a comparator to compare the read pointer and the write pointer.

6. The dispatcher module of claim 5, the comparator further to assert a task arbiter enable signal if the read pointer and write pointer do not match.

7. The dispatcher of claim 1, the unit arbiter further to receive state signals from each of a group of processing units.

8. The dispatcher of claim 1, the dispatcher further comprising a memory to store an identifier for a previously used processing unit.

9. The dispatcher of claim 1, the dispatcher to produce a valid response signal, a processing unit identifier for a selected processing unit, and a program counter signal.

10. The dispatcher of claim 1, the task arbiter and the unit arbiter to employ a round-robin arbiter sequence.

11. A system comprising:
an ingress buffer to accept incoming data packets having headers;
a parser to parse the headers and determine tasks to be accomplished based upon the headers;
an array of processing units;
a central processing unit;
a dispatcher to:
monitor status of each processing unit in the array of processing units;
receive a task request from one of the parser, the central processing unit and the array of processing units;
assign tasks selected from the task requests to processing units based upon the status, such that the tasks selected are not assigned to a previously assigned processing unit.

12. The system of claim 11, each processing unit in the array of processing units having a state machine coupled to the dispatcher, such that the state machine provides input regarding the status of the processing unit.

13. The system of claim 11, the dispatcher further comprising a task arbiter to select tasks from the task requests.

14. The system of claim 11, the dispatcher further comprising a unit arbiter to assign processing units based upon the status of each processing unit.

15. The system of claim 11, the dispatcher further comprising a queue to store task requests.

16. The system of claim 11, the dispatcher to assign tasks further to produce a signal indicating an offset into the ingress buffer and a program counter to the processing unit assigned a task when the task is from the parser.

17. The system of claim 11, the dispatcher to assign tasks further to produce a program counter, an initial SEP address, and arguments, when the task is from the central processing unit.

18. The system of claim 11, the dispatcher to assign tasks further to produce a program counter and arguments, when the task is from another processing unit.

19. A method of distributing tasks, comprising:
determining if there is a task request waiting;
determining if there is at least one processing unit available;
assigning a task associated with the request to an available processing unit, such that the task is not assigned to a previously assigned processing unit, if there are more than two processing units available;
advancing a write pointer for the available processing unit; and
storing an identifier for the available processing unit as the previously assigned processing unit.

20. The method of claim 19, determining if there is a task request waiting further comprises comparing a write pointer and a read pointer for a queue to determine if the write pointer and the read pointer are not the same.

21. The method of claim 19, determining if there is at least one processing unit available further comprising monitoring inputs from an array of processing units.

22. The method of claim 19, further comprising assigning the available processing unit if there is only one available processing unit without regard to the previously assigned processor.

23. The method of claim 19, assigning a task to an available processing unit further comprising assigning the task to an available processing unit with the highest priority.

24. The method of claim 19, further comprising rearranging priorities for available processing units after assignment of a task, based upon which processing unit was assigned the task.
